(19) United States
(12) Patent Application Publication
(10) Pub. No.: US 2024/0393046 A1
(43) Pub. Date: Nov. 28, 2024

(54) CENTRIFUGAL DRYER MACHINE

(71) Applicant: TURATTI S.R.L., CAVARZERE (IT)

(72) Inventor: Daniele MEAZZO, CAVARZERE (IT)

(73) Assignee: TURATTI S.R.L., CAVARZERE, VE (IT)

(21) Appl. No.: 18/697,400

(22) PCT Filed: Sep. 28, 2022
(86) PCT No.: PCT/IT2022/050264

§ 371 Date: Mar. 29, 2024

(30) Foreign Application Priority Data
Sep. 29, 2021 (IT) 102021000024863

(51) Int. Cl. F26B 5/08; A23N 12/08

(52) U.S. Cl. CPC F26B 5/08; A23N 12/086

(57) ABSTRACT

A centrifugal dryer machine for drying a product, including a support frame, a perforated drum, substantially cylindrical in shape, having a first end open and a second end closed, a motor provided with a shaft connected to the drum, where the shaft is integrally coupled to the second end of the drum.

The present invention concerns a centrifugal dryer machine.

In detail, the invention concerns a centrifugal dryer with high structural strength and capable of improving the degree of drying of the final product and its quality in general.

Such features are very important, especially in the field of processing large quantities of food products on an industrial level, such as leafy vegetables or the like.

Currently known centrifuges include a perforated drum, which is housed within a frame and constrained to rotate about its own axis.

The drum containing the product to be dried is moved by one or more wheels connected to a motor and to the drum itself; the wheels may be connected to the drum by direct contact with its outer wall, or by respective belts.

In machines in which the drum is oriented substantially horizontally, it usually has a cylindrical or truncated-cone symmetry, in which the two opposite ends are open.

Thus, it is possible to load the product to be dried through one end by means of conveyors that distribute it along the entire length of the drum, while unloading takes place through the opposite end.

There are also solutions in which the drum rotates about an essentially vertical axis, in which the introduction and subsequent removal of the product from the drum occurs through the same opening, located at its top.

However, currently known centrifugal dryers have some drawbacks.

First, these drawbacks relate to the handling and support of the drum during machine operation.

In machines that employ wheels in direct contact with the side surface of the drum, the wheels themselves manage to provide adequate support, however, the stiffness of the system increases.

In addition, the rotational speeds achieved are never very high, especially if the drum is of considerable size.

In fact, from the standpoint of practicality and economic feasibility, the tolerances that can be achieved in the construction of the drum hinder sliding between the contact surfaces of the wheels and the drum.

If the wheels were to work at much higher speeds, it would also increase surface wear and consequently the frequency of necessary maintenance activities.

In machines that adopt drive belts, these are able to support the drum during rotation and absorb more of its oscillations, however, they possess less efficiency in transmitting motion.

In addition, since belts function as motor organs, they experience significant stresses, so they must have sufficient size and strength, and they also suffer from increased wear and tear.

In general, the size of the drum cannot grow excessively because of the drawbacks mentioned so far and because of the difficulties in balancing the rotating masses.

As a result, for the same amount of drying time spent in the machine, the amount of product processed in a set time is limited.

It is possible to decrease the standing time of the product in the drum to process a larger amount, but worsening its degree of drying and leaving more residual moisture.

On the other hand, if there is too much product in the drum, its final quality worsens, as the layers in contact with the side wall of the drum itself are crushed and damaged by the layers accumulated above when the drum rotates.

In addition, the rotational speed of the drum cannot be increased to separate more water from the product in a shorter time, because this would be damaged by the increased centrifugal force that would crush it on the side wall of the drum.

In addition, because of the poor efficiency in transmitting motion from the motor to the drum, an increase in the speed of rotation of the drum, or its size, would cause a significant increase in the energy to be supplied to the motor.

The centrifugal drying machine according to the present invention makes it possible to solve the mentioned drawbacks.

Specifically, the centrifugal dryer according to the invention allows the speed of rotation of the drum to be increased while limiting energy losses.

In addition, the centrifugal dryer according to the invention makes it possible to increase the quality of the final product through the use of a drum having an increased size that allows for better distribution of the product within it.

Similarly, the centrifugal dryer according to the invention makes it possible to minimize damage caused to the product during processing.

Finally, the centrifugal dryer according to the invention allows the product to be processed more efficiently, and cost-effectively by virtue of the advantages achieved.

It is therefore an object of the present invention to provide a centrifugal dryer machine for drying a product, comprising a support frame, a perforated drum, substantially cylindrical in shape, having a first open end and a second closed end, a motor having a shaft connected to the drum, wherein the shaft is attached solidly to the second end of the drum; the machine further comprises a plurality of pulleys rotatably connected to the frame near the first end of the drum.

The machine may additionally comprise a plurality of belts, each connected to a respective pulley and drum, so as to transmit the load of the drum to the frame and to transmit the rotation of the drum to the pulleys.

In a preferred embodiment, the drum and shaft are configured to rotate, when the centrifugal dryer is in operation, about an axis, coincident with the central axis of symmetry of the drum and inclined with respect to the horizontal direction so that the first end faces downward.

Preferably, the angle of inclination of the axis is between 10° and 40°.

Even more preferably, the axis tilt angle is 20°.

Additionally, the centrifugal machine may include between three and five pulleys and respective belts.

Additionally, the machine may include grooves, for guiding the belts, cut on the drum near its first end.

The machine may also include a conveyor belt, for distributing the product in the drum, movable along the horizontal direction or along a direction parallel to the axis.

Finally, in preferred forms of machine construction, the pulleys are idler.

The present invention will now be described, by way of example and not limitation, according to some of its preferred embodiments, and with the aid of the appended figures, in which:

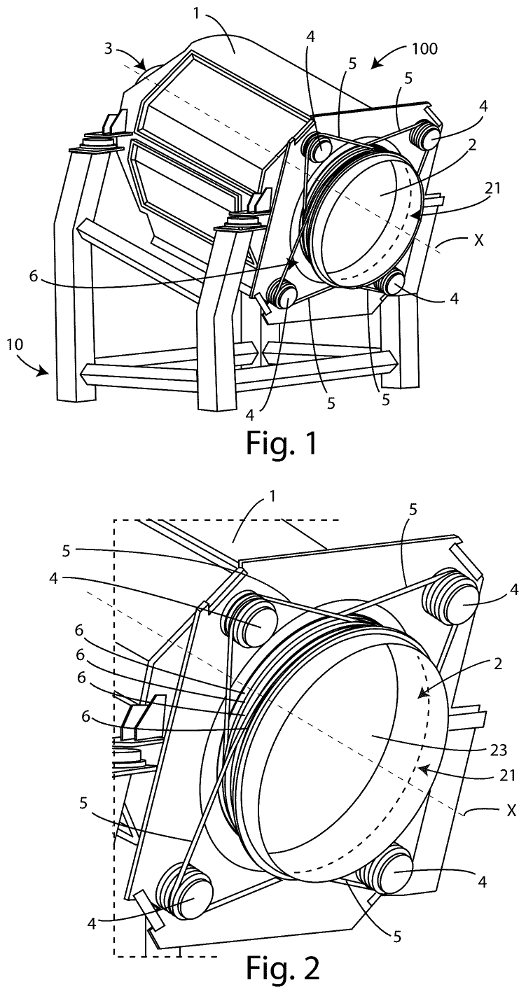

FIG. 1 is a schematic perspective view of a first form of embodiment of the centrifugal dryer machine according to the invention;

FIG. 2 shows a detail of the embodiment of FIG. 1;

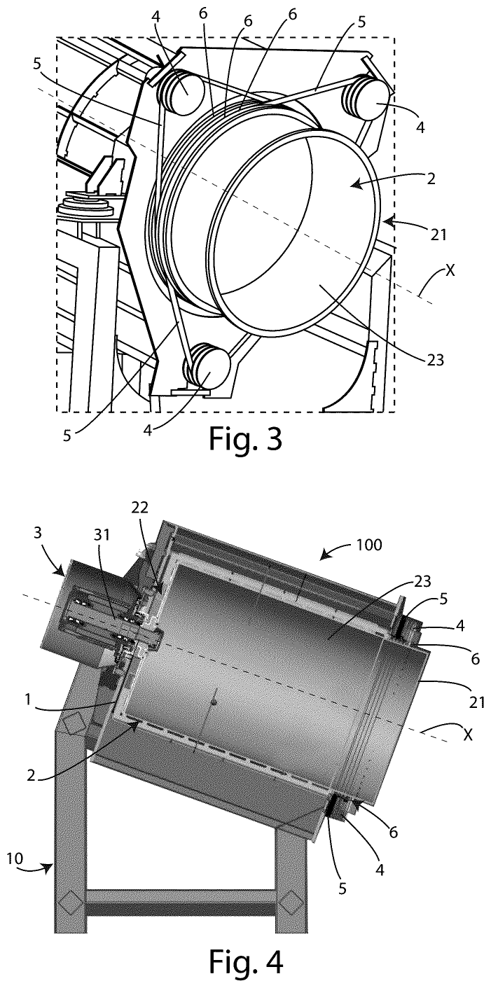

FIG. 3 shows a detail of a second embodiment of the machine according to the invention;

FIG. 4 is a side sectional view of the machine according to the invention.

Referring now to FIGS. 1-4, a centrifugal dryer 100 is shown comprising a frame 1, attached to supports 10.

Centrifuge 100 also includes a drum 2, a motor 3, and pulleys 4 attached to frame 1.

The drum 2, which is basically cylindrical in shape, has an open first end 21, a closed second end 22 and a side wall 23.

The material to be processed is introduced, and subsequently discharged, from drum 2 through the first end 21, while shaft 31 of motor 3 is attached to the second end 22.

Side wall 23 has holes to allow separation and expulsion of water during rotation.

Preferably, the drum 2 is made of lightweight materials with high stress resistance, such as polymeric or composite materials.

In such a case, because shaft 31 is attached integrally to drum 2, the transmission of motion occurs more smoothly and efficiently than the known art, resulting in less impact on the amount of energy absorbed and on the machine components themselves.

In addition, the machine is overall stiffer and stronger than those using an indirect connection between motor and drum, which allows for better control of vibrations and an increase in the size of the drum and/or its rotational speed.

The drum 2 and shaft 31 are configured to rotate, when the centrifuge 100 is in operation, about an X axis, coincident with the central axis of symmetry of drum 2.

During operation of the centrifuge 100, the X-axis, and thus also the drum 2, are preferably tilted from the horizontal direction so that the first end 21 faces downward.

Preferably, the inclination angle of the X-axis is between 10° and 40°; in preferred embodiment, this angle is 20°.

The downward inclination of the open end of drum 2 promotes the discharge of the processed material after the end of the drying operation and decreases the damage to the product itself by partially using the inertia force resulting from the rotary motion to discharge it in a way that minimizes creep on the side wall 23 of drum 2 itself.

Referring to FIGS. 2-4, in the event that the drum has a weight greater than can be sustained by the motor shaft alone, for example due to the oscillations generated by the masses during its movement, the machine may include pulleys 4, attached to the frame 1 at the first end 21 of drum 2.

Each pulley 4 is free to rotate about its own axis, essentially parallel to the X axis, and is connected to a belt 5, respectively.

Each belt 5, in addition, is connected to drum 2, in contact with its outer wall

Preferably, grooves 6 are cut into the outer wall of the drum 2 at the first end 21, so that they lie substantially adjacent to the pulleys 4.

The grooves 6 act as guides for the belts 5 and prevent them from slipping out of the drum 2.

Preferably, the wall of drum 2 is not perforated in the contact area of the belts 5.

In fact, when drum 2 is in motion, pulleys 4 are idle and function as wheels driven by a driving wheel through belts 5.

The driving wheel, in this case, is represented by drum 2, which in turn is put into rotation by motor 3 via shaft 31.

The belts 5 and pulleys 4 have functions of support for the first end 21 of drum 2, which is cantilevered from the interlocking constraint represented by shaft 31, as well as further restraint of oscillations and imbalances due to the moving masses, and stabilization in general.

Preferably, there are between three and five belts and their respective pulleys evenly arranged on frame 1.

The pulleys 4 are positioned symmetrically and regularly spaced from the drum 2 with respect to its X axis.

This ensures optimal absorption of forces and oscillations in different directions and quieter operation.

In addition, since belts do not have a driving function, they can be of reduced size or thickness and require less frequent and more economical maintenance operations.

In preferred forms of implementation, there are four pulleys arranged as at the vertices of a quadrilateral centered with respect to the X axis, or three pulleys arranged as at the vertices of a triangle.

Operationally, the introduction of the material to be processed is through the first open end 21.

In preferred embodiments, the machine 100 includes a conveyor belt (not shown) that evenly distributes the product in the drum 2.

Preferably, the belt is movable along the horizontal direction and/or along a direction parallel to the X axis so that the product can be distributed along the entire side wall 23.

Preferably, during the loading phase, the drum 2 rotates at a reduced speed such that the material can adhere to the wall 23 by centrifugal force without being damaged.

Once the loading phase is complete, the speed increases to carry out drying.

At the end of the drying phase, the speed is reduced again to allow the dried product to be discharged by a combination of the forces of inertia and gravity, so that it is at least partially detached from the wall and projected outward.

Product creep on the wall and consequent damage as a result of contact with the edges of the holes on the wall is thus minimized, which would be more likely if the product were slid by gravity alone.

In any case, if necessary, the rotation can be stopped totally and the product discharged by gravity.

A machine designed in this way makes it possible to increase the size of the drum and/or its rotation speed, thanks to the direct connection between motor and drum and the optional stabilizing belts.

As a result, by loading an equal amount of product into the drum, compared to machines of the known art, it is distributed more evenly on the side wall and with a lower density per unit area of the drum.

Experimental results show that this configuration limits the percentage of damage suffered by the product from 75% to 100%, also reduces the residual moisture after drying from 20% to 75%.

The invention thus conceived and illustrated herein is susceptible to numerous modifications and variations, all within the scope of the inventive concept.

Furthermore, all details may be replaced by other technically equivalent elements.

Finally, the components used, provided they are compatible with the specific use, as well as the dimensions, may be any according to the needs and state of the art.

Where features and techniques mentioned in any claim are followed by reference marks, such reference marks have been appended for the sole purpose of increasing the intelligibility of the claims and, accordingly, such reference marks have no limiting effect on the interpretation of each element identified by way of example by such reference marks.

1-9. (canceled)

10. A centrifugal dryer machine for drying a product, comprising:
a support frame,
a perforated drum substantially cylindrical in shape, and having a first end open and a second end closed, and
a motor provided with a shaft connected to the drum, wherein
the shaft is integrally coupled to the second end of the drum.

11. The centrifugal dryer machine according to claim 10, further comprising a plurality of pulleys rotatably connected to the frame near the first end of the drum, and
a plurality of belts, each belt of the plurality of belts connected to a respective pulley and to the drum, so as to transmit load of the drum to the frame and to transfer rotation of the drum to the pulleys.

12. The centrifugal dryer machine according to claim 10, wherein the drum and the shaft are configured to rotate when the centrifuge is in operation, about an axis coincident with the central axis of symmetry of the drum and inclined with respect to the horizontal direction, so that the first end faces downwards.

13. The centrifugal dryer machine according to claim 12, wherein the angle of inclination of the axis is between 10° and 40°.

14. The centrifugal dryer machine according to claim 13, wherein the angle of inclination of the axis is 20°.

15. The centrifugal dryer machine according to claim 10, further comprising three to five pulleys and respective belts.

16. The centrifugal dryer machine according to claim 10, further comprising grooves for guiding the belts, provided on the drum near its first end.

17. The centrifugal dryer machine according to claim 10, further comprising a conveyor belt for distributing the product in the drum, the conveyor belt movable along the horizontal direction or along a direction parallel to the axis.

18. The centrifugal dryer machine according to claim 10, wherein the pulleys are idle.
